(19) United States
(12) Patent Application Publication
(10) Pub. No.: US 2009/0259654 A1
(43) Pub. Date: Oct. 15, 2009

(54) INFORMATION PROCESSING APPARATUS, CONTROL METHOD THEREOF, AND STORAGE MEDIUM

(75) Inventor: Keiichi Yamamoto, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/409,474

(22) Filed: Mar. 23, 2009

(30) Foreign Application Priority Data
Apr. 9, 2008 (JP) 2008-101817

(51) Int. Cl. G06F 17/30; G06F 3/048

(52) U.S. Cl. 707/5; 707/3; 715/764; 707/100; 707/E17.005; 707/E17.014

(57) ABSTRACT

An information processing apparatus includes: a read unit adapted to read first content information in which a characteristic of first content is written; an extraction unit adapted to extract rule information in which a characteristic that is common among one or more items of second content is written by analyzing second content information in which characteristics of the second content are written; and an update unit adapted to update the first content information based on the first content information and the rule information.

### BACKGROUND OF THE INVENTION

1. Field of the Invention

The present invention relates to an information processing apparatus, a control method thereof, and a storage medium, and more particularly to a technique for managing content by assigning content information.

2. Description of the Related Art

In recent years, easy-to-use data creation apparatuses, such as digital cameras, word processors, sound creation apparatuses, and music creation apparatuses have been developed. In addition, with the development of computers equipped with high-capacity storage apparatuses and products equipped with such computers, larger amounts of data have come to be stored. Due to this, users must select the desired data from among the large amounts of data stored in the storage apparatuses. However, it requires labor and time and is very annoying for users to check data one by one to select the desired data.

In the case where the data is text data, using a character-string search makes it possible to select the desired data to some extent. In the case where the data is image data without any text data, however, the user has to visually check the image data one by one to select the desired image data. Such a task requires labor and time, and it is practically impossible with a large amount of data.

To address this, a method is known in which content information is added to the data that does not have text data, such as image data, and a search is performed using the content information. It is also known that digital cameras manufactured in recent years come with a configuration in which content information called “Exif data” is automatically assigned to an image when captured. Exif data is content information in which information regarding shooting data when an image is captured by the camera, including the captured date and time, camera model name, camera owner, shutter speed, aperture value, captured location provided by GPS, and so on, is written. Such a configuration is widely used to acquire the desired image data by using the Exif data as a search target.

However, the amount of information contained in Exif data is small, and it is therefore difficult to accurately select desired data using only Exif data. To address this, a configuration is known in which the user can assign, as new content information, image data information including event names, such as “Sports Day” and “Travel”, people names, and so on after capturing, aside from the Exif data. With this configuration, the desired image data can be selected by searching for the newly assigned content information as a search target. However, it requires a considerable amount of labor and time for the user to assign content information to a large number of data items one by one. For this reason, it is often the case that the user neglects to assign content information, making it difficult to select the desired data.

In contrast thereto, Japanese Patent Laid-Open No. 2005-196598 discloses a configuration in which a commonality is searched for in a plurality of items of content information, and if constituent elements that are identical to each other, or constituent elements that have a certain degree of relevance to each other are found in each piece of content information, a union of the constituent elements is created for that content information, and the content information is automatically updated. This configuration eliminates the laborious task of assigning similar content information to all of the content.

As described above, the configuration disclosed in Japanese Patent Laid-Open No. 2005-196598 merely creates a union of constituent elements for each piece of content information, and automatically updates the content information. Accordingly, in order to assign content information to the content, the user has to manually collect content items relevant to one another by determining the relevance between content items, which is a cumbersome task.

### SUMMARY OF THE INVENTION

The present invention has been conceived in view of the above problems, and the present invention aims to provide a technique with which it is possible to further reduce the work involved in assigning content information to content items.

According to one aspect of the present invention, an information processing apparatus includes: a read unit adapted to read first content information in which a characteristic of first content is written; an extraction unit adapted to extract rule information in which a characteristic that is common among one or more items of second content is written by analyzing second content information in which characteristics of the second content are written; and an update unit adapted to update the first content information based on the first content information and the rule information.

According to another aspect of the present invention, a method for controlling an information processing apparatus includes the steps of: reading first content information in which a characteristic of first content is written; extracting rule information in which a characteristic that is common among one or more items of second content is written by analyzing second content information in which characteristics of the second content are written; and updating the first content information based on the first content information and the rule information.

According to still another aspect of the present invention, a computer-readable storage medium stores a program for allowing a computer to execute a method for controlling an information processing apparatus, the method comprising: reading first content information in which a characteristic of first content is written; extracting rule information in which a characteristic that is common among one or more items of second content is written by analyzing second content information in which characteristics of the second content are written; and updating the first content information based on the first content information and the rule information.

Further features of the present invention shall become apparent from the following description of exemplary embodiments with reference to the attached drawings.

### BRIEF DESCRIPTION OF THE DRAWINGS

FIG. 1 is a block diagram illustrating an example of the hardware configuration of a content management apparatus 100.

FIG. 2 is a block diagram illustrating an example of the software configuration of the content management apparatus 100.

FIG. 3 is a conceptual diagram illustrating an example of how content is detected.

FIG. 4 is a conceptual diagram illustrating an example of how content information is updated.

FIG. 5 is a flowchart illustrating an example of a content information application process.

FIG. 6 is a flowchart illustrating an example of a content information application cancellation process.

FIG. 7 is a schematic diagram illustrating an example of a dialog box for querying a user as to whether or not to apply a rule.

FIG. 8 is a schematic diagram illustrating an example of a dialog box for querying a user as to whether or not to apply a rule on a rule-by-rule basis.

FIG. 9 is a schematic diagram illustrating an example of a screen that allows a user to select whether or not to apply a rule for each item of content.

FIG. 10 is a conceptual diagram illustrating an example of a case where the need to overwrite content information arises.

FIG. 11 is a schematic diagram illustrating an example of a screen that queries a user as to whether or not to apply a rule when the need to overwrite content information arises.

### DESCRIPTION OF THE EMBODIMENTS

Hereinafter, embodiments of the present invention shall be described in detail with reference to the accompanying drawings. However, it should be noted that the constituent elements described in these embodiments are merely exemplary, and are not intended to limit the scope of the present invention. It should also be noted that all the combinations of the features described in the embodiments are not necessary to solve the problems of the present invention.

### Embodiment 1

In the present embodiment, a configuration in which a content group is first detected, a content information application rule is extracted from the content group, and that rule is applied to another content group shall be described with reference to the drawings.

(Hardware Configuration)

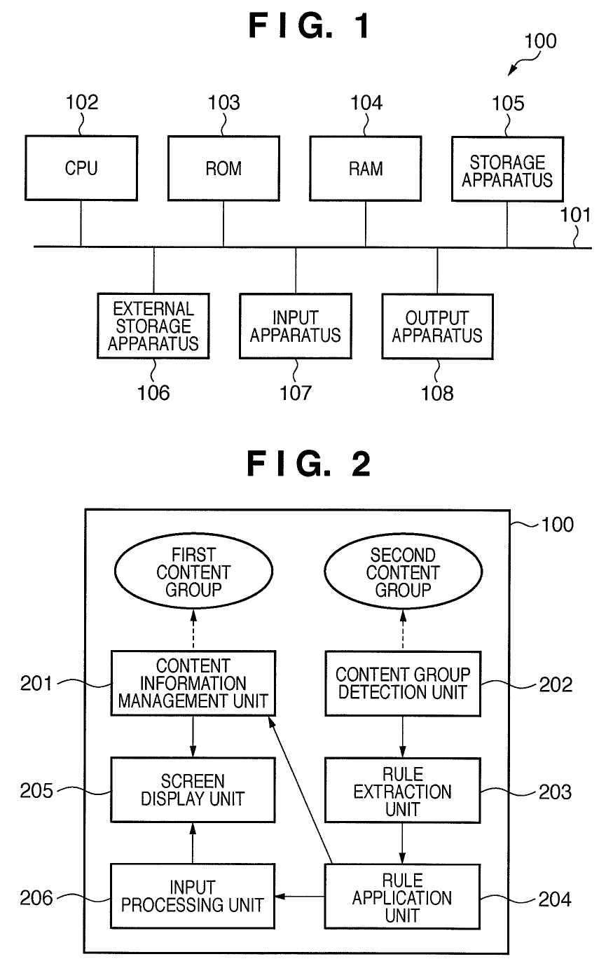

FIG. 1 is a block diagram illustrating an example of a hardware configuration of a content management apparatus 100 as an information processing apparatus according to the present embodiment. Reference numeral 102 denotes a CPU (central processing unit), which performs computations and logical determinations for various processes and controls the constituent elements connected to a bus 101.

The content management apparatus 100 is provided with memories including a program memory and a data memory. The program memory stores a program that contains various process procedures, which shall be described later with reference to flowcharts, and that is controlled by the CPU. This memory can be a ROM (read-only memory) 103, or a RAM (random access memory) 104 into which programs are loaded from an external storage apparatus or the like. Alternatively, it may be implemented by a combination thereof.

Reference numeral 105 denotes a storage apparatus for storing data and programs according to the present embodiment, such as a hard disk. In the present embodiment, the storage apparatus is also used to store content. As an apparatus for storing content, it is also possible to use a content storage apparatus connected through an external connection or to a network. As an apparatus that functions similarly to the storage apparatus 105, an external storage apparatus 106 may be used. The external storage apparatus 106 can be implemented by, for example, a medium (recording medium) and an external storage drive for achieving access to the medium. Well-known examples of such a medium include a flexible disk (FD), a CD-ROM, a DVD, a USB memory, an MO, a flash memory, and so on.

Reference numeral 107 denotes an input apparatus for inputting instructions from the user. The user provides instructions to the content management apparatus 100 via the input apparatus 107. The input apparatus 107 can be implemented by, for example, a keyboard or pointing device.

Reference numeral 108 denotes an output apparatus, realized by a display unit that displays/outputs the results and the like of a process performed by the content management apparatus 100. The output apparatus 108 can be implemented by, for example, a display apparatus such as a CRT (cathode-ray tube) or liquid-crystal display that includes a circuit for output. In the present embodiment, the content management apparatus 100 displays items of content arranged in a specific order in the output apparatus (display apparatus) 108.

(Software Configuration)

FIG. 2 is a block diagram illustrating an example of the software configuration of the content management apparatus 100 according to the present embodiment.

Reference numeral 201 denotes a content information management unit, which reads and writes content information (first content information) attached to a first content group. The content information may be stored in the data of the first content, or the content management apparatus (information processing apparatus) 100 may store the information. The first content group refers to a set (content group) of content items (first content) that have been detected by the content management apparatus 100 in advance, and that are under the management of the content information management unit 201. For example, it can be a content group that is stored in the storage apparatus 105, but it also encompasses content groups that are stored in an external medium, external connection device and network connection device, content groups that are published on a network or the web, etc., as long as the content groups are already detected by the content management apparatus 100.

The first content information is information in which the characteristics of the first content are written, such as, for example, the date and time at which the content was generated, the generation location, and the event name when the content was generated. Detailed examples of the content information shall be described later.

The content information management unit 201 further stores reference information (information that specifies the content location, such as an URL or file path) for the content. The content information management unit 201 provides or updates content information, content itself, thumbnail images of content, and so on, in response to requests from other modules.

Reference numeral 202 denotes a content group detection unit, which detects a second content group. The second content group refers to a set of new content items (second content) that have not been managed by the content information management unit, and includes one or more items of second content. For example, the second content group can be a content group that is stored in an external apparatus such as an external medium, external connection device or network connection device, a content group that is published on a network or the Web, etc. The content group detection unit 202 detects a new content group when an external medium is inserted, when a device is connected, when content on a network is selected, etc. The content group detection unit 202 also acquires second content information that corresponds to the second content. In the present embodiment, the content group detection unit 202 acquires the second content information attached to the second content, but the second content information may be acquired by analyzing the second content.

Reference numeral 203 denotes a rule extraction unit, which extracts a content information application rule (rule information) from the second content group. That is, the rule extraction unit 203 extracts rule information in which a characteristic that is common among the items of the second content contained in the second content group is written by analyzing the second content information in which the characteristics of the second content is written.

Reference numeral 204 denotes a rule application unit, which requests the content information management unit 201 to update the content information of the first content group based on the rule extracted by the rule extraction unit 203. The rule application unit 204 determines, based on the first content information and the rule, whether or not there is relevance between the first content and the second content of the second content group. If it is determined that there is relevance between the content, the rule application unit 204 updates the first content information based on the rule.

Reference numeral 205 denotes a screen display unit, which writes information from the content information management unit 201, an inquiry screen for a user from an input processing unit 206, and the like in a graphic RAM of the output apparatus 108 as graphic data. Reference numeral 206 denotes an input processing unit, which requests the screen display unit 205 to display inquiries for the user. The input processing unit 206 also analyzes user operations from the input apparatus 107, and performs processes such as selecting an operation, inputting data, etc.

(Content Detection)

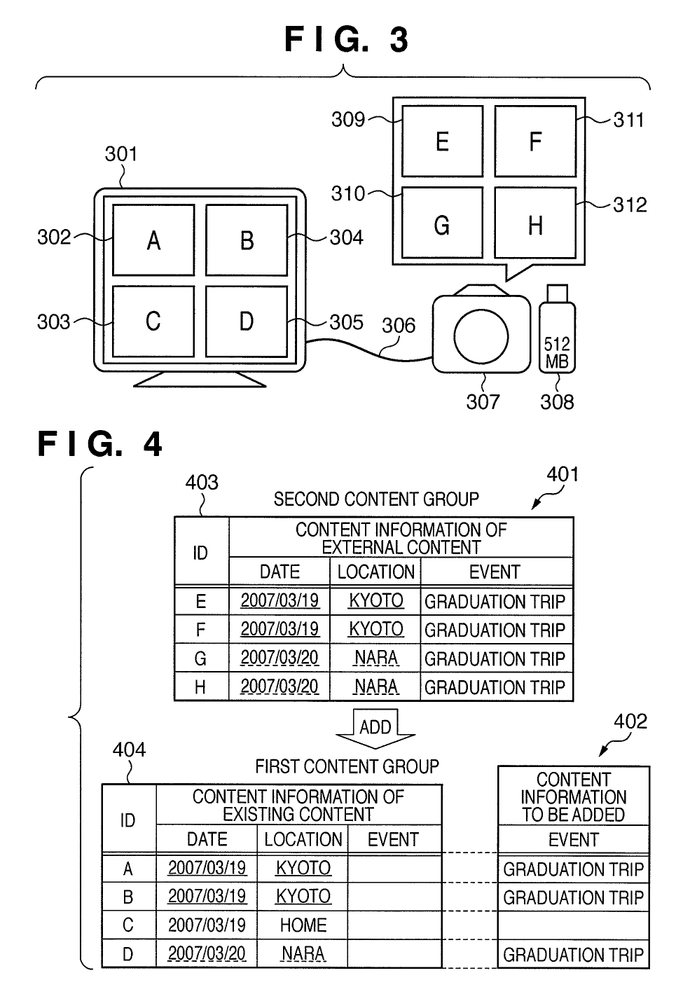

Next, an overview of a process for detecting a new content group shall be described with reference to FIG. 3. FIG. 3 is a conceptual diagram illustrating an example of how content detection according to the present embodiment is performed.

Reference numeral 301 denotes a display screen, which is an example of the output apparatus 108 of FIG. 1. The content output from the content management apparatus 100 is displayed on the display screen 301. An example is shown in which existing content items 302 to 305 managed by the content management apparatus 100 are displayed on the screen.

In this state, if a digital camera 307 is connected to the content management apparatus 100 with a connection cable 306, or if an external medium (USB memory) 308 is connected to the content management apparatus 100 via a USB port, external content items 309 to 312 that are stored in the newly connected device are detected by the content management apparatus 100. In FIG. 3, the content items stored in the digital camera 307 or the USB memory 308 are shown as an example of the external content items to be detected. Other than this, content stored in a device capable of storing content, such as a network storage, a media server, a PC or a HDD recorder, content published on a network or the Web, or the like may be detected.

(Content Information Update)

Next, an overview of a process for updating the content information managed by the content information management unit 201 that is performed when a new content group is detected shall be described with reference to FIG. 4. FIG. 4 is a conceptual diagram illustrating an example of how the content information is updated according to the present embodiment.

In FIG. 4, the first content group denotes a set of existing content items that are managed by the content management apparatus 100. The second content group denotes a set of external content items that are newly detected by the content management apparatus 100.

Tables 401 and 402 of FIG. 4 show exemplary content information of content. In the tables, ID columns 403 and 404 show content identification information, and the IDs listed therein correspond to the content items 302 to 305 and 309 to 312 indicated by A to H in FIG. 3.

First, the content management apparatus 100 detects content items E to H that constitute a second content group as described in FIG. 3, and extracts a content information application rule from the second content group. As an example, the extraction is performed by extracting a rule based on a commonality of the content information. That is, a rule in which a characteristic that is common in the content items of the second content group is written is extracted by analyzing the second content information in which the characteristics of the content items are written.

For example, the content items with content IDs of E and F match in terms of date, location and event of the content information, which are “2007/03/19”, “Kyoto”, and “Graduation Trip” respectively, and thus, it is determined that commonalities exist between them. This is referred to as, for example, Rule 1. Similarly, the content items with content IDs of G and H also match in terms of date, location and event of the content information, which are “2007/03/20”, “Nara”, and “Graduation Trip” respectively, and thus, it is determined that commonalities exist between them. This is referred to as, for example, Rule 2. In the example of FIG. 3, commonality is found from at least two content items, but it is also possible to determine the commonality based on the relevance between one content item and the first content group.

Next, the content management apparatus 100 applies the extracted rule to the first content group. That is, the content management apparatus 100 updates the first content information based on the extracted rule. In the present embodiment, however, content items whose content information has high relevance to the common rule extracted from the second content group are selected from the first content group, and then processed. Accordingly, in the present embodiment, it is determined, based on the first content information and the extracted rule, whether or not there is relevance between the first content and the second content, and the first content information is updated based on the rule if it is determined that there is relevance.

In the present embodiment, when a characteristic that is the same as the first content information is written in the extracted rule and a characteristic that is contradictory to the first content information is not written in the extracted rule, it is determined that there is relevance between this rule and the first content information. When updating the first content information based on the rule, the update is performed by adding a characteristic that is not written in the first content information but is written in the rule to the first content information.

For instance, in the example of FIG. 3, the content items with content IDs of A and B have the same date and location, namely, “2007/03/19” and “Kyoto”, in the content information, and therefore, they match Rule 1 described above in terms of date and location in the content information. Accordingly, it is determined that there is relevance between the content information of the content items with content IDs of A and B and Rule 1. Note that the content information in the event column for the content items with content IDs of A and B is blank. Accordingly, the content management apparatus 100 adds “Graduation Trip”, which has been assigned to Rule 1, to the event column to update the content information.

Similarly, the content item with a content ID of D has “2007/03/20” and “Nara” in the date column and the location column of the content information, and it matches Rule 2 described above in terms of date and location in the content information. It is determined, from this, that there is relevance between the content information of the content item with a content ID of D and Rule 2. Accordingly, the content management apparatus 100 performs an update by adding “Graduation Trip”, which has been assigned to Rule 2, to the event column of the content information for the content item with a content ID of D.

The content item with a content ID of C has “home” in the location column of the content information. Although its date happens to be the same as that of the graduation trip, its location is neither “Nara” nor “Kyoto”. Accordingly, because the location characteristic is contradictory to those of Rules 1 and 2, it is determined that there is no relevance between the rules and the content information, and the content item with a content ID of C will not be updated.

It is also possible to employ a configuration in which similar content items are determined based on an image feature using image recognition techniques, and that feature is used as a rule.

In the description of FIG. 4, upon detection of a second content group, a rule is extracted from the second content group, and the rule is applied to a first content group, but the configuration is not limited thereto. It is also possible to, for example, extract a rule from first content items when a second content group is detected, and apply the rule to the second content group. This configuration can be used when it is necessary to bring a rule to the outside. By applying that rule to the user's environment, the content information of the user's environment can be made more robust as well. In this manner, it becomes possible to spread the rules of the environment to which the content information has been assigned.

(Content Information Application Process)

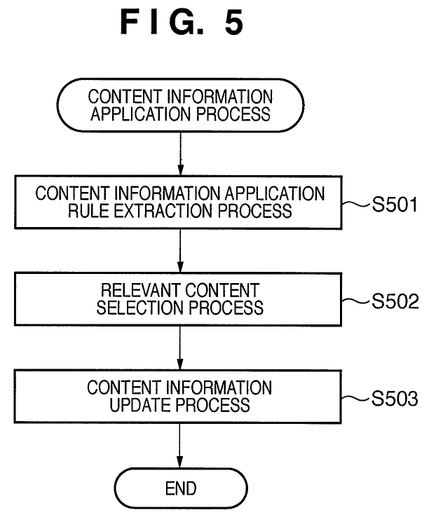

A content information application process executed by the content management apparatus 100 shall be described next in detail with reference to FIG. 5. FIG. 5 is a flowchart illustrating an example of a content information application process according to the present embodiment.

In FIG. 5, steps S501 to S503 each represent a step. The processes of the steps are executed through control performed by the CPU 102 upon detection of a second content group by the content management apparatus 100.

In step S501, Rule 1 or Rule 2 is extracted from the second content group as described with reference to FIG. 4. As the extraction of the rule, as described above, a rule in which a characteristic that is common to one or more second content items included in the second content group is written is extracted by analyzing the second content information in which the characteristics of the second content items are written. Specifically, for example, the content with exactly the same content information is searched for, and if such content is not found, the number of items of content information, based on which a match is determined, can be gradually reduced. That is, if the total number of items of content information is five, a search is first conducted for content with all of the five content information items matching, and if such content is not found, the number of items of content information, based on which a match is determined, is gradually reduced to four, three, and so on. FIG. 4 shows an example in which two rules with three items (Date, Location and Event) matching are found.

In step S502, the relevance between the common content information (rule information) extracted in step S501 and the content information of the first content group is determined, and content items that have been determined to have relevance are selected from the first content group. As a specific process for selecting relevant content items, for example, content items with a large number of items of content information that match the common content information extracted in step S501 can be selected. If five matching content information items are found in step S501, content items with four matching items out of the five items are selected from the first content group. If such a content item is not found, the number of items, based on which a match is determined, is gradually reduced to three, two, and so on. If a content item with exactly the same content information is found, the rule will not be subjected to subsequent processes. FIG. 4 shows an example in which content items with two matching items (Date and Location) out of three items (Date, Location and Event) were selected.

In step S503, the content information of the content items selected as having relevance to the rule in step S502 is updated based on the rule. In the example of FIG. 4, content information that is included in the rule but is not included in the first content group is assigned. That is, in the example of FIG. 4, because the event column of the first content group was empty when the content items were selected, the content information of the event column of the second content group is added to the event column of the first content group.

As described above, according to the present embodiment, the relevance between the first content and the second content is automatically determined based on the first content information and the rule extracted from the second content group, and if it is determined that there is relevance, the first content information is updated based on that rule. Accordingly, there is no need for the user to determine the relevance of content, and the first content information can be appropriately updated simply by causing the content management apparatus 100 to recognize a second content group.

In the present embodiment, it is determined that there is relevance between the first content and the second content when a characteristic that is the same as the first content information is written in the ruler and a characteristic that is contradictory to the first content information is not written in the rule. Accordingly, it is possible to prevent the content information from being updated with a rule having a contradictory characteristic.

In addition, because the first content information is updated by adding, to the first content information, a characteristic that is not written in the first content information, but is written in the rule, the details of the first content information can be filled out based on the rule.

Furthermore, in the present embodiment, upon the detection of a second content group, operations are performed to extract a rule, determine the relevance between first content information and the rule, and update the first content information. Accordingly, it is only necessary for the user to cause the content management apparatus 100 to detect a second content group in order to update the first content information appropriately. Because the content management apparatus 100 detects content items stored in an external apparatus as second content, the user only needs to connect the external apparatus to the content management apparatus 100.

As described above, with the content management apparatus 100 of the present embodiment, the rules of the environment that is organized by assignment of content information can be applied to another environment simply by carrying the content in a memory card or the like. Thus, in an ordinary situation where the user removes the content with the content information and shares the content with others at a gathering or the like, the content information can be easily assigned simply by causing the content to be detected by an environment to which the content information has never been assigned.

### Embodiment 2

The present embodiment describes a configuration in which the cancellation of rule application is performed, with reference to the drawings. The cancellation may be effected by a cancellation operation by the user, or may be effected when the content group is no longer detected. Here, an example in which the cancellation is performed when the content group is no longer detected shall be described.

(Overview)

The present embodiment shall discuss, as an example, a case where, in FIG. 3, after an external device, such as a digital camera 307 or external medium (USB memory) 308, is connected to the content management apparatus 100 and the content items 309 to 312 are detected, content items are no longer detected due to, for example, the external device being disconnected. Other cases where the content group is no longer detected, such as the external device being accidentally turned off, the external device shutting down due to an error, and a network communication failure, can also be considered.

It is assumed that, in FIG. 4, a second content group is detected, and “Graduation Trip” is added to the event column of the first content group. In the present embodiment, update history is recorded in the storage apparatus 105 or the like each time the first content information is updated. After that, if the external device is disconnected and the second content group is no longer detected, the added “Graduation Trip” is removed based on the recording of the history to restore the column to an original blank state. Through this, it is possible to temporarily apply the rule of the second content group to the first content group.

(Content Information Cancellation Process)

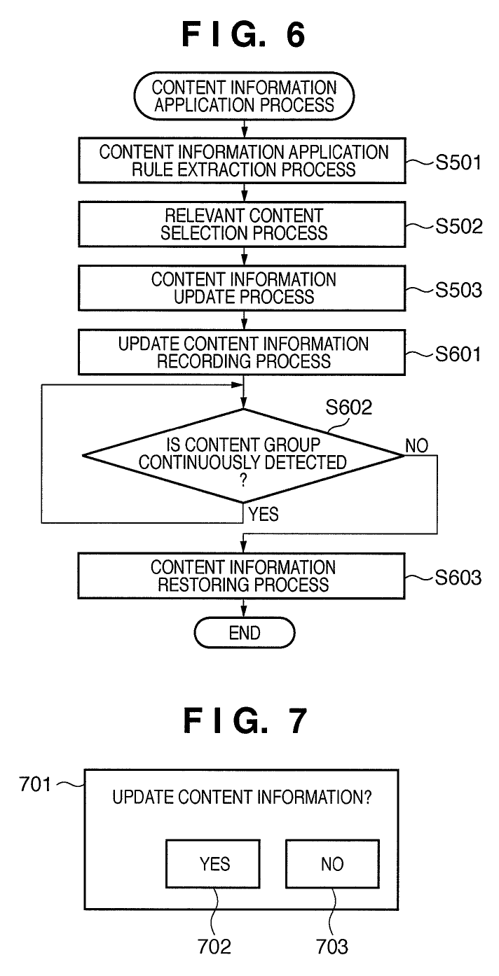

A content information cancellation process executed by the content management apparatus 100 shall be described next in detail with reference to FIG. 6. FIG. 6 is a flowchart illustrating an example of a content information application cancellation process according to the present embodiment.

In FIG. 6, steps S601 to S603 each represent a step. This process is executed when a second content group is detected by the content management apparatus 100. The steps S501 to S503 are the same as those of FIG. 5.

After steps S501 to S503, in step S601, the details of the content information applied in step S503, that is, the update history of the first content information, is recorded in the storage apparatus 105 or the like. The recording can be performed by, for example, pairing the content ID with the columns and details of the added content information. Specifically, taking FIG. 4 as an example, for the content items with content IDs of A, B, and D, the information that “Graduation Trip” has been added in the event column can be stored.

In step S602, it is determined whether or not the detected second content group is still continuously detected. The procedure remains the same while the second content group is detected, but if the second content group is no longer detected, and No (no longer detected) is determined in step S602, the process of step S603 is performed.

In step S603, a process for restoring the details of the updated first content information to the details before being updated based on the history information stored in step S601 is performed. When the content information is updated by adding a characteristic that is not written in that content information but is written in the rule, the content information added in step S601 has been stored. Accordingly, in step S603, the added content information and a content ID thereof are specified, and the added information is deleted.

Specifically, taking FIG. 4 as an example, in the content items with content IDs of A, B, and D, “Graduation Trip” is deleted from the event column. With this process, the first content group returns to the state it was in before the second content group was detected. In the example of FIG. 6, the loop determines whether the second content is continuously detected, but the content information restore process may be performed when an event that is no longer detected is received, instead of repeating the loop.

As described above, according to the present embodiment, each time the first content information is updated, the history is recorded. Then, the details of the updated first content information is restored to the details before being updated based on the recorded history. Therefore, when it is necessary to restore the first content information, the information can be restored appropriately.

Furthermore, in the present embodiment, the details of the first content information are restored when the second content items included in the second content group are no longer detected. Accordingly, the updating and restoring of content information can be executed with a simple operation.

As described above, with the content management apparatus 100 of the present embodiment, the application of a rule can be temporarily stopped. This can be used in such a situation where the user wants to remove a rule after the application of the rule, or where, for example, when the user brings the content to a friend's house where a search is performed using the content information assigned to that content, the user decides that it is unnecessary to leave that content information in the friend's environment.

### Embodiment 3

The present embodiment describes a configuration in which the user can select whether or not to apply a rule with reference to the drawings. Examples of such a configuration include a configuration that allows the user to select whether or not to apply a rule to all of the content, and a configuration that allows the user to select whether or not to apply a rule on a rule-by-rule basis. Other possibilities include a configuration that allows the user to select whether or not to apply a rule for each item of content while directly confirming the content item on a screen on which a list of thumbnails of the content is displayed, and a configuration that provides an alert and allows the user to select whether or not to apply a rule when it is necessary to overwrite the existing content information if the rule is applied. Hereinafter, several exemplary configurations that allow the user to select whether or not to apply a rule shall be described.

### CONFIGURATION EXAMPLE 1

First, an example shall be described in which the user selects whether or not to apply a rule to all of the content. FIG. 7 is a schematic diagram illustrating an example of a dialog box for querying the user as to whether or not to apply a rule according to the present embodiment.

In FIG. 7, 701 denotes a dialog box for the user to confirm whether the content information may be updated due to application of a rule. This dialog box is output to and displayed on the output apparatus 108 when there is content information to be updated.

Reference numeral 702 denotes a “Yes” button, which indicates that the user chooses to perform the update. If the user pushes (selects) this button, the content information will be updated accordingly.

Reference numeral 703 denotes a “No” button, which indicates that the user chooses not to perform the update. If the user pushes this button, the content information will not be updated. It is thus possible to prevent the content information from being updated contrary to user's intention.

### CONFIGURATION EXAMPLE 2

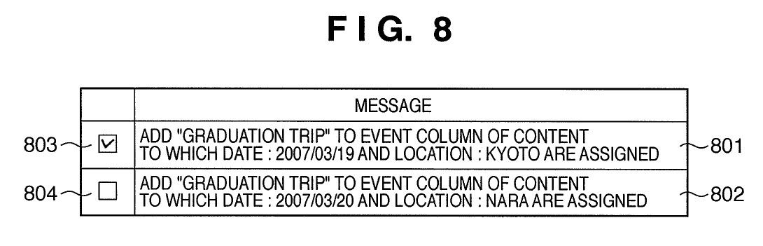

Next, an example shall be described that allows the user to select whether or not to apply a rule on a rule-by-rule basis. FIG. 8 is a schematic diagram illustrating an example of a dialog box for inquiring with a user as to whether or not to apply a rule on a rule-by-rule basis according to the present embodiment.

In FIG. 8, Reference numerals 801 and 802 denote confirmatory messages for the user, and the messages are displayed for each rule. The example of 801 indicates that Add “Graduation Trip” to Event column of content to which “Date: 2007/03/19, Location: Kyoto” has been assigned. As shown in FIG. 8, in this example, a checkbox indicated by 803 and 804 is provided for each confirmatory message, and only the checked items are enabled. Other than checkboxes, it is also possible to use expressions such as assigning a mark, highlighting the outer frame of a confirmatory message, changing the font size of a confirmatory message from that of other confirmatory messages, flashing a confirmatory message, or changing the chroma, brightness, or tint of the font color or background color of a confirmatory message from that of other confirmatory messages. With this configuration, it is possible for the user to apply only a necessary rule. It is also possible to find a contradictory rule from the confirmatory messages.

### CONFIGURATION EXAMPLE 3

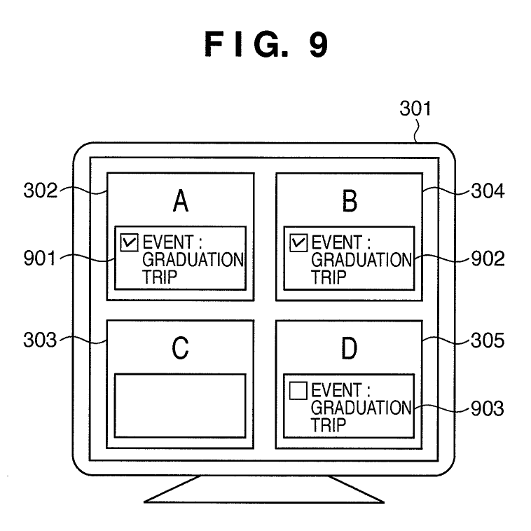

Next, an exemplary configuration in which the user can select whether or not to apply a rule for each item of content while directly confirming the content on a screen on which a list of thumbnails of the content is displayed shall be described with reference to FIG. 9. FIG. 9 is a schematic diagram illustrating an example of a screen that allows the user to select whether or not to apply a rule for each item of content.

This configuration example shall be described taking the state shown in FIGS. 3 and 4 as an example. In FIG. 9, similar to FIG. 3, content items 302 to 305 are displayed on the display screen 301. At this time, as shown in FIG. 4, for the content items with content IDs of A, B, and D, “Graduation Trip” is added to the event column of the content information. Accordingly, in FIG. 9, confirmatory icons indicated by 901 to 903 are displayed near the thumbnails of the content. These indicate that the content information, namely, “Graduation Trip” will be added to the content items A, B, and D in association with these content items. A checkbox is provided in each icon, and the user can select whether or not to update the content information for each item of content by selecting this checkbox. Other than checkboxes, it is also possible to use expressions such as assigning a mark, highlighting the outer frame of the content, changing the size of the content from that of other content items, flashing the content, changing the chroma, brightness, or tint of the content from that of other content items, or adding a shadow to the content.

With this configuration, the user can determine whether the content information to be added is appropriate while confirming the details of the content items, and it is therefore possible to prevent unintended content information from being assigned.

### CONFIGURATION EXAMPLE 4

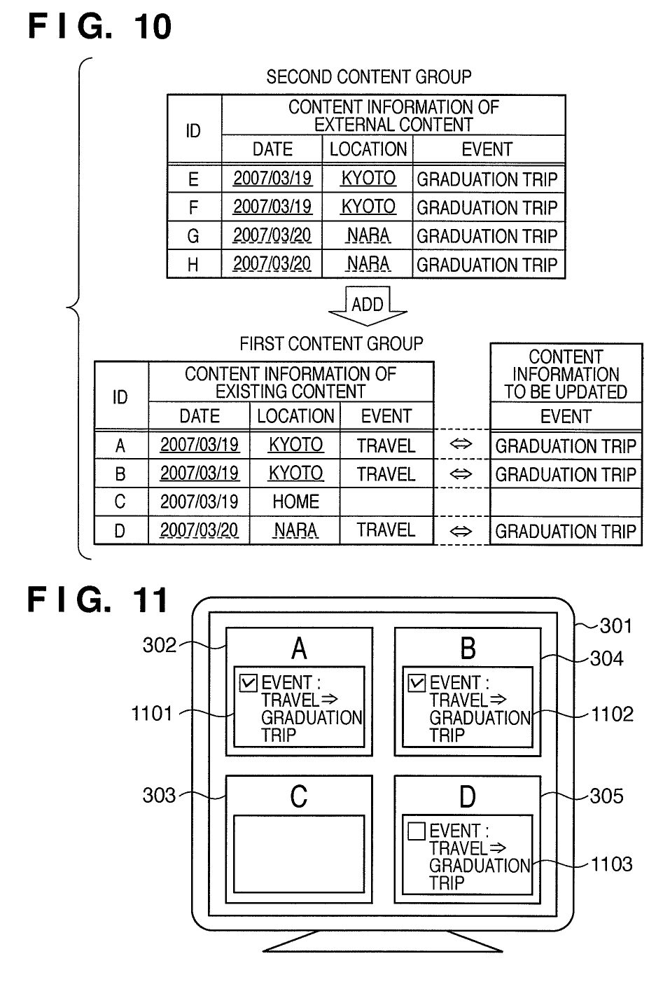

Next, an exemplary configuration that provides an alert and allows the user to select whether or not to apply a rule when it is necessary to overwrite the existing content information if the rule is applied shall be described. FIG. 10 is a conceptual diagram illustrating an example of a case where the need to overwrite content information arises according to the present embodiment.

In FIG. 10 as well, as an example, a state is assumed in which a change similar to that of FIG. 4 takes place, except that the content information “Travel” is already assigned to the event column for the content items with content IDs of A, B, and D of the first content group. In this case, the content information “Graduation Trip” of the second content group and the content information “Travel” of the first content group do not match, or in other words, they are contradictory to each other. Accordingly, if this rule is applied, the content information “Travel” of the content items A, B, and D of the first content group will be overwritten by “Graduation Trip”. If such a case occurs, in order to prevent the content information from being updated contrary to user's intention, it is desirable to prompt the user for confirmation.

FIG. 11 is a schematic diagram illustrating an example of a screen that queries the user as to whether or not to apply a rule when the need to overwrite the content information arises according to the present embodiment. As already described with reference to FIG. 10, the content information of the content items A, B, and D needs to be overwritten. Accordingly, icons indicated by 1101 to 1103 indicating that the content information will be overwritten are displayed. Here, the icons indicate that “Travel” of the event column will be overwritten by “Graduation Trip”. A checkbox is provided for each icon, so that the user can select whether or not to update the content information for each item of content. With this configuration, it is possible to prevent the content information from being inadvertently overwritten contrary to user's intention.

As described above, in the present embodiment, first content information to be updated is displayed on the output apparatus 108 to prompt the user to confirm whether or not to update the first content information, and the first content information is updated if a confirmation for the update is obtained. Thus, according to the configuration of the present embodiment, it is possible to prevent the content information from being updated contrary to the user's intention.

In addition, in the present embodiment, because thumbnail images of the first content are displayed on the output apparatus 108, the user can set whether or not to update content information while confirming the content.

Furthermore, in the present embodiment, because whether a characteristic of first content information is overwritten when the first content information is updated is detected, and if it is determined that overwriting is necessary, a message indicating that the characteristic will be overwritten is displayed. Accordingly, it is possible to effectively prevent the content information from being update contrary to user's intention.

As described above, with the content management apparatus 100 of the present embodiment, it is possible to avoid the application of an unintended rule, improving security.

### Other Embodiments

Needless to say, the object of the present invention is also achieved by executing the program code of software that implements the functions of the above-described embodiments with a system or apparatus. In this case, the program code itself implements the functions of the above-described embodiments, and the program code falls within the technical scope of the present invention.

The program code can be, for example, supplied to the system or apparatus by being recorded to a computer-readable recording medium. A computer (or CPU or MPU) of the system or apparatus can also achieve the object of the present invention by reading and executing the program code stored in the recording medium. Accordingly, the recording medium storing the program code also falls within the technical scope of the present invention.

Examples of storage media that can be used to supply the program code include flexible disk, hard disk, optical disk, magneto-optical disk, CD-ROM, CD-R, magnetic tape, nonvolatile memory card, ROM, DVD, and so on.

Moreover, the program code need not include all of the elements for implementing the functions of the above-described embodiments by a computer reading and executing the program code. That is, program code that achieves the object in coordination with at least one of software and hardware included in a computer also falls within the technical scope of the present invention.

For example, in the case where an OS or the like running on a computer performs part or all of the actual processing based on instructions of the program code, and the functions of the above-described embodiments are implemented by that processing, this program code also falls within the technical scope of the present invention. Incidentally, OS stands for operating system.

Alternatively, for example, a case may occur in which a CPU or the like provided in a function expansion board or a function expansion unit inserted into or connected to a computer performs part or all of the actual processing based on instructions of program code, and the functions of the above-described embodiments are implemented by that processing. In such a case, the program code also falls within the technical scope of the present invention. Note that the function expansion board or the function expansion unit can perform such processing by reading the program code to a memory provided therein and executing the read program code.

As described above, according to the present invention, with a simple task of carrying the content of a content group to which content information has been assigned in a memory card or the like, it is possible to assign the content information to an environment to which the content information has not been assigned. Accordingly, content information can be made more robust simply by sharing content to which content information has been assigned, without requiring the user to assign the content information, so both the provider of content information and the recipient of the content information can be freed from having to perform the assignment operations.

According to the present invention, it is possible to provide a technique with which it is possible to further reduce the work involved in assigning content information to content items.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-101817, filed on Apr. 9, 2008, which is hereby incorporated by reference herein in its entirety.

What is claimed is:

1. An information processing apparatus comprising:
a read unit adapted to read first content information in which a characteristic of first content is written;
an extraction unit adapted to extract rule information in which a characteristic that is common among one or more items of second content is written by analyzing second content information in which characteristics of the second content are written; and
an update unit adapted to update the first content information based on the first content information and the rule information.

2. The information processing apparatus according to claim 1, further comprising
a determination unit adapted to determine whether or not there is relevance between the first content and the one or more items of second content based on the first content information and the rule information,
wherein the update unit updates the first content information when the determination unit determines that there is relevance.

3. The information processing apparatus according to claim 2,
wherein the determination unit determines that there is relevance when a characteristic that is the same as the first content information is written in the rule information and a characteristic that is contradictory to the first content information is not written in the rule information.

4. The information processing apparatus according to claim 1,
wherein the update unit updates the first content information by adding, to the first content information, a characteristic that is not written in the first content information but is written in the rule information.

5. The information processing apparatus according to claim 2, further comprising:
a detection unit adapted to detect content stored in an external apparatus as the second content,
wherein the extraction unit, the determination unit and the update unit operate upon detection of the second content by the detection unit.

6. The information processing apparatus according to claim 5, further comprising:
a recording unit adapted to record a history of the first content information that has been updated by the update unit; and
a restoring unit adapted to restore details of the first content information that has been updated by the update unit to pre-update details, based on the history recorded in the recording unit.

7. The information processing apparatus according to claim 6,
wherein the restoring unit restores the details of the first content information when the second content is no longer detected by the detection unit.

8. The information processing apparatus according to claim 1, further comprising
a confirmation unit adapted to display the updated first content information on a display and confirm with a user whether or not to update the first content information.
wherein the update unit updates the first content information when the confirmation unit obtains a confirmation for the update.

9. The information processing apparatus according to claim 8,
wherein the confirmation unit displays a thumbnail image of the first content on the display for the confirmation.

10. The information processing apparatus according to claim 8, further comprising
an overwrite detection unit adapted to detect whether or not a characteristic of the first content information will be overwritten when the update unit updates the first content information,
wherein, when the overwrite detection unit detects that the characteristic of the first content information will be overwritten, the confirmation unit displays a message indicating that the characteristic of the first content information will be overwritten on the display.

11. A method for controlling an information processing apparatus comprising the steps of:
reading first content information in which a characteristic of first content is written;
extracting rule information in which a characteristic that is common among one or more items of second content is written by analyzing second content information in which characteristics of the second content are written; and
updating the first content information based on the first content information and the rule information.

12. A computer-readable storage medium storing a program for allowing a computer to execute a method for controlling an information processing apparatus, the method comprising:
reading first content information in which a characteristic of first content is written;
extracting rule information in which a characteristic that is common among one or more items of second content is written by analyzing second content information in which characteristics of the second content are written; and
updating the first content information based on the first content information and the rule information.
